(19) United States
(12) Patent Application Publication
(10) Pub. No.: US 2024/0005468 A1
(43) Pub. Date: Jan. 4, 2024

(54) IMAGE DISTORTION EVALUATION METHOD AND APPARATUS, AND COMPUTER DEVICE

(71) Applicant: Beijing Bytedance Network Technology Co., Ltd., Beijing (CN)

(72) Inventors: Yao XIAO, Beijing (CN); Yang ZHANG, Beijing (CN)

(21) Appl. No.: 18/034,631

(22) PCT Filed: Nov. 4, 2021
(86) PCT No.: PCT/CN2021/128760

§ 371 Date: Apr. 28, 2023

(30) Foreign Application Priority Data
Nov. 11, 2020 (CN) 202011251740.4

(51) Int. Cl. G06T 7/00; G06T 7/41; G06T 5/00

(52) U.S. Cl. CPC G06T 7/0002; G06T 2207/30168; G06T 5/001; G06T 7/41

(57) ABSTRACT

An image distortion evaluation method and apparatus, and a computer device. The method comprises: acquiring an original image and an enhanced image; respectively performing partitioning processing on the original image and the enhanced image, so as to obtain a plurality of first blocks of the original image and a plurality of second blocks of the enhanced image; acquiring a preset proportionate window size that accords with the characteristics of human eye vision, and according to the proportionate window size, respectively compiling statistics on first proportion information entropies respectively corresponding to the plurality of first blocks of the original image and second proportion information entropies respectively corresponding to the plurality of second blocks of the enhanced image; determining a visual texture loss degree of the enhanced image according to the first proportion information entropies corresponding to the first blocks and the second proportion information entropies corresponding to the second blocks.

### CROSS-REFERENCE

This application is filed based on the Chinese patent application No. 202011251740.4 with a filing date of Nov. 11, 2020, and a title of “IMAGE DISTORTION EVALUATION METHOD AND APPARATUS, AND COMPUTER DEVICE”, and claims priority to the Chinese Patent Application. All contents of the Chinese Patent Application are incorporated herein by reference.

### TECHNICAL FIELD

The present disclosure relates to the field of image analysis, in particular to an image distortion evaluation method and apparatus, and a computer device.

### BACKGROUND

Image enhancement is a general name for a series of technologies that enhance useful information of images and improve visual effects of images. After image enhancement, distortion of enhanced images relative to original images is generally evaluated.

When image distortion is evaluated, one method is to analyze pixel differences for evaluation, which cannot reflect visual texture losses of enhanced images. Another method is to compute the losses through model training, but is limited in application scenarios due to high computational complexity.

### SUMMARY

Embodiments of the present disclosure provide at least an image distortion evaluation method and apparatus, and a computer device, to evaluate a visual texture loss of an enhanced image while reducing computational complexity.

In a first aspect, embodiments of the present disclosure provide an image distortion evaluation method, comprising:
obtaining an original image and an enhanced image, wherein the enhanced image is generated by image enhancement on the original image;
performing block processing on the original image and the enhanced image separately to obtain a plurality of first blocks of the original image and a plurality of second blocks of the enhanced image;
obtaining a preset scale window size that conforms to human visual characteristics, and collecting statistics on a first scale information entropy corresponding to each of the plurality of first blocks of the original image and a second scale information entropy corresponding to each of the plurality of second blocks of the enhanced image according to the scale window size; and
determining a degree of visual texture loss of the enhanced image according to the first scale information entropy corresponding to each first block and the second scale information entropy corresponding to each second block.

In one optional embodiment, wherein the collecting statistics on a first scale information entropy corresponding to each of the plurality of first blocks of the original image and a second scale information entropy corresponding to each of the plurality of second blocks of the enhanced image according to the scale window size comprises:
determining adjusted gray value distribution information corresponding to each of the plurality of first blocks of the original image based on initial gray value distribution information corresponding to each of the plurality of first blocks of the original image and the scale window size, and determining the first scale information entropy corresponding to each of the plurality of first blocks based on the adjusted gray value distribution information corresponding to each of the plurality of first blocks; and
determining adjusted gray value distribution information corresponding to each of the plurality of second blocks of the enhanced image based on initial gray value distribution information corresponding to each of the plurality of second blocks of the enhanced image and the scale window size, and determining the second scale information entropy corresponding to each of the plurality of second blocks based on the adjusted gray value distribution information corresponding to each of the plurality of second blocks, wherein
the number of pixels corresponding to each gray value in the adjusted gray value distribution information is a sum of pixels of each gray value in a target scale window corresponding to the gray value in the initial gray value distribution information; and a size of the target scale window matches the scale window size that conforms to human visual characteristics.

In one optional embodiment, wherein the determining a degree of visual texture loss of the enhanced image according to the first scale information entropy corresponding to each first block and the second scale information entropy corresponding to each second block comprises:
determining a first information entropy difference between the original image and the enhanced image according to the first scale information entropy corresponding to each first block and the second scale information entropy corresponding to each second block; and
determining the degree of visual texture loss of the enhanced image based on the first information entropy difference.

In one optional embodiment, wherein the method further comprises:
determining, based on initial gray value distribution information corresponding to each of the plurality of first blocks of the original image, a first initial information entropy corresponding to each first block, and determining, based on initial gray value distribution information corresponding to each of the plurality of second blocks of the enhanced image, a second initial information entropy corresponding to each second block; and
determining a second information entropy difference between the original image and the enhanced image according to the first initial information entropy corresponding to each first block and the second initial information entropy corresponding to each second block;
wherein the determining the degree of visual texture loss of the enhanced image based on the first information entropy comprises:
determining the degree of visual texture loss of the enhanced image based on the first information entropy difference and the second information entropy difference.

In one optional embodiment, wherein the initial gray value distribution information and the adjusted gray value distribution information are used as target gray value distribution information separately, and a target information entropy is determined according to the following steps, wherein the target information entropy is the first scale information entropy, the second scale information entropy, the first initial information entropy, or the second initial information entropy:
using the first blocks and the second blocks as target blocks separately, and for each target block, determining the target information entropy corresponding to the target block based on the number of pixels, indicated by the target gray value distribution information, corresponding to each gray value of the target block, and the total number of pixels corresponding to the target block.

In one optional embodiment, wherein a target information entropy difference is determined according to the following steps, wherein the target information entropy difference is the first information entropy difference or the second information entropy difference:
dividing differences of information entropies between corresponding blocks of the enhanced image and the original image into a first class and a second class, wherein the differences of information entropies in the first class are greater than or equal to 0, and the differences of information entropies in the second class are less than 0;
setting the differences of information entropies in the first class to 0, computing a standard deviation of the differences of information entropies in the second class, and determining, based on the standard deviation and the difference of information entropies corresponding to any block in the second class, a standardized difference of information entropies corresponding to the block; and
determining the target information entropy difference based on the processed difference of information entropies between the corresponding blocks of the enhanced image and the original image.

In one optional embodiment, wherein the determining the degree of visual texture loss of the enhanced image based on the first information entropy difference and the second information entropy difference comprises:
determining a union information entropy difference between the corresponding blocks of the enhanced image and the original image based on the first information entropy difference and the second information entropy difference between the corresponding blocks of the enhanced image and the original image; and
using a sum of union information entropy differences between the respective corresponding blocks of the enhanced image and the original image as a value to measure the degree of texture loss of the enhanced image.

In one optional embodiment, wherein the determining a union information entropy difference between the corresponding blocks of the enhanced image and the original image based on the first information entropy difference and the second information entropy difference between the corresponding blocks of the enhanced image and the original image comprises:
computing a square root of a sum of squares of the first information entropy difference and the second information entropy difference, and using a value of the square root as the union information entropy difference.

In a second aspect, embodiments of the present disclosure provide an image distortion evaluation apparatus, comprising:
an obtaining module, configured to obtain an original image and an enhanced image, wherein the enhanced image is generated by image enhancement on the original image;
a block module, configured to perform block processing on the original image and the enhanced image separately to obtain a plurality of first blocks of the original image and a plurality of second blocks of the enhanced image;
a statistics module, configured to obtain a preset scale window size that conforms to human visual characteristics, and collect statistics on a first scale information entropy corresponding to each of the plurality of first blocks of the original image and a second scale information entropy corresponding to each of the plurality of second blocks of the enhanced image according to the scale window size; and
a determination module, configured to determine a degree of visual texture loss of the enhanced image according to the first scale information entropy corresponding to each first block and the second scale information entropy corresponding to each second block.

In one optional embodiment, wherein the statistics module, when collecting statistics on a first scale information entropy corresponding to each of the plurality of first blocks of the original image and a second scale information entropy corresponding to each of the plurality of second blocks of the enhanced image according to the scale window size, is configured to:
determining adjusted gray value distribution information corresponding to each of the plurality of first blocks of the original image based on initial gray value distribution information corresponding to each of the plurality of first blocks of the original image and the scale window size, and determining the first scale information entropy corresponding to each of the plurality of first blocks based on the adjusted gray value distribution information corresponding to each of the plurality of first blocks; and
determining adjusted gray value distribution information corresponding to each of the plurality of second blocks of the enhanced image based on initial gray value distribution information corresponding to each of the plurality of second blocks of the enhanced image and the scale window size, and determining the second scale information entropy corresponding to each of the plurality of second blocks based on the adjusted gray value distribution information corresponding to each of the plurality of second blocks, wherein
the number of pixels corresponding to each gray value in the adjusted gray value distribution information is a sum of pixels of each gray value in a target scale window corresponding to the gray value in the initial gray value distribution information; and a size of the target scale window matches the scale window size that conforms to human visual characteristics.

In one optional embodiment, wherein the determination module, when determining a degree of visual texture loss of the enhanced image according to the first scale information entropy corresponding to each first block and the second scale information entropy corresponding to each second block, is configured to:
determining a first information entropy difference between the original image and the enhanced image according to the first scale information entropy corresponding to each first block and the second scale information entropy corresponding to each second block; and
determining the degree of visual texture loss of the enhanced image based on the first information entropy difference.

In one optional embodiment, the statistics module is further configured to:
determining, based on initial gray value distribution information corresponding to each of the plurality of first blocks of the original image, a first initial information entropy corresponding to each first block, and determining, based on initial gray value distribution information corresponding to each of the plurality of second blocks of the enhanced image, a second initial information entropy corresponding to each second block; and
determining a second information entropy difference between the original image and the enhanced image according to the first initial information entropy corresponding to each first block and the second initial information entropy corresponding to each second block;
wherein the determining the degree of visual texture loss of the enhanced image based on the first information entropy comprises:
determining the degree of visual texture loss of the enhanced image based on the first information entropy difference and the second information entropy difference.

In one optional embodiment, wherein the statistics module determines a target information entropy according to the following steps after using the initial gray value distribution information and the adjusted gray value distribution information as target gray value distribution information separately, where the target information entropy is the first scale information entropy, the second scale information entropy, the first initial information entropy, or the second initial information entropy:
using the first blocks and the second blocks as target blocks separately, and for each target block, determining the target information entropy corresponding to the target block based on the number of pixels, indicated by the target gray value distribution information, corresponding to each gray value of the target block, and the total number of pixels corresponding to the target block.

In one optional embodiment, wherein the determination module determines a target information entropy difference according to the following steps, wherein the target information entropy difference is the first information entropy difference or the second information entropy difference:
dividing differences of information entropies between corresponding blocks of the enhanced image and the original image into a first class and a second class, wherein the differences of information entropies in the first class are greater than or equal to 0, and the differences of information entropies in the second class are less than 0;
setting the differences of information entropies in the first class to 0, computing a standard deviation of the differences of information entropies in the second class, and determining, based on the standard deviation and the difference of information entropies corresponding to any block in the second class, a standardized difference of information entropies corresponding to the block; and
determining the target information entropy difference based on the processed difference of information entropies between the corresponding blocks of the enhanced image and the original image.

In one optional embodiment, wherein the determination module, when determining the degree of visual texture loss of the enhanced image based on the first information entropy difference and the second information entropy difference, configured to:
determining a union information entropy difference between the corresponding blocks of the enhanced image and the original image based on the first information entropy difference and the second information entropy difference between the corresponding blocks of the enhanced image and the original image;
using a sum of union information entropy differences between the respective corresponding blocks of the enhanced image and the original image as a value to measure the degree of texture loss of the enhanced image.

In one optional embodiment, wherein the determination module, when determining a union information entropy difference between the corresponding blocks of the enhanced image and the original image based on the first information entropy difference and the second information entropy difference between the corresponding blocks of the enhanced image and the original image, is configured to:
computing a square root of a sum of squares of the first information entropy difference and the second information entropy difference, and using a value of the square root as the union information entropy difference.

In a third aspect, embodiments of the present disclosure provide a computer device, comprising a processor, a memory, and a bus, wherein the memory stores machine-readable instructions executable by the processor; when the computer device is running, the processor communicates with the memory through the bus; and when the machine-readable instructions are executed by the processor, the steps of the first aspect, or any one of the possible implementations of the first aspect are executed.

In a forth aspect, embodiments of the present disclosure provide a computer-readable storage medium, wherein the computer-readable storage medium stores a computer program, and the computer program is run by a processor to execute the steps of the first aspect or any one of the possible implementations of the first aspect.

According to the image distortion evaluation method and apparatus, and the computer device provided in the embodiments of the present disclosure, an original image and an enhanced image after image enhancement are first obtained; the original image and the enhanced image are processed in blocks separately, a preset scale window size that conforms to human visual characteristics is obtained, and statistics on a first scale information entropy corresponding to each of a plurality of first blocks of the original image and a second scale information entropy corresponding to each of a plurality of second blocks of the enhanced image are collected separately according to the scale window size; and a degree of visual texture loss of the enhanced image is determined according to the first scale information entropy corresponding to each first block and the second scale information entropy corresponding to each second block. By introducing a scale window, scale information entropies corresponding to the original image and the enhanced image that conform to the human visual characteristics more can be obtained, and the visual texture loss of the enhanced image can be evaluated more accurately without model training and on the premise of reducing computational complexity.

In order to make the foregoing objectives, features, and advantages of the present disclosure more apparent and understandable, detailed explanations are provided below with reference to preferred embodiments and accompanying drawings.

### BRIEF DESCRIPTION OF THE DRAWINGS

In order to more clearly illustrate the technical solutions of the embodiments of the present disclosure, a brief description of the accompanying drawings, which are incorporated herein and form part of the specification, and which illustrate embodiments consistent with the present disclosure and are used in conjunction with the specification to illustrate the technical solutions of the present disclosure, is set forth below. It should be understood that the following figures illustrate only certain embodiments of the present disclosure and therefore should not be considered as limiting the scope, and that other relevant figures may be obtained from these figures without creative effort by one of ordinary skill in the art.

FIG. 1 shows a flowchart of an image distortion evaluation method provided in an embodiment of the present disclosure;

FIG. 2 shows a histogram used to represent initial gray value distribution information in an image distortion evaluation method provided in an embodiment of the present disclosure;

FIG. 3 shows a histogram used to represent adjusted gray value distribution information in an image distortion evaluation method provided in an embodiment of the present disclosure;

FIG. 4 shows a complete flowchart of obtaining a union information entropy difference in an image distortion evaluation method provided in an embodiment of the present disclosure;

FIG. 5 shows a schematic diagram of an image distortion evaluation apparatus provided in an embodiment of the present disclosure; and

FIG. 6 shows a schematic diagram of a computer device provided in an embodiment of the present disclosure.

### DETAILED DESCRIPTION OF PREFERRED EMBODIMENTS

To make the purpose, technical solutions and advantages of embodiments of the present disclosure clearer, a clear and complete description of the technical solutions in embodiments of the present disclosure is set forth below in connection with the accompanying drawings in embodiments of the present disclosure, and it is clear that the embodiments described are only a portion of the embodiments of the present disclosure and not all of them. The components of the embodiments of the present disclosure generally described and illustrated in the accompanying drawings herein may be arranged and designed in a variety of different configurations. Accordingly, the following detailed description of embodiments of the present disclosure provided in the accompanying drawings is not intended to limit the scope of the present disclosure for which protection is claimed, but rather indicates only selected embodiments of the present disclosure. Based on embodiments of the present disclosure, all other embodiments obtained by those skilled in the art without creative labor fall within the scope of protection of the present disclosure.

For distortion caused by image enhancement, if the distortion is evaluated by directly computing pixel differences, a visual texture loss of the enhanced image cannot be obtained. If the visual texture loss is computed through model training, the computation is highly complex and relatively inefficient.

On this basis, an embodiment of the present disclosure provides an image distortion evaluation method, which evaluates, without model training, a visual texture loss caused by image enhancement, with low computational complexity, and is also applicable to some scenarios with limited computing resources.

The discovery process of the above problem and the solutions provided by the present disclosure below against the above problem should all be contributions made by the inventor to the present disclosure during disclosure. The following clearly and completely describes the technical solutions in the embodiments of the present disclosure with reference to the accompanying drawings in the embodiments of the present disclosure.

It should be noted that similar reference signs and letters in the following drawings represent similar terms, so once a term is defined in a drawing, the term does not need to be further defined and explained in the follow-up drawings.

For easy understanding of this embodiment, an image distortion evaluation method disclosed in the embodiment of the present disclosure is first described in detail. An executive subject of the image distortion evaluation method provided in the embodiment of the present disclosure is generally a computer device with computing power. The computer device includes, for example, a terminal device, a server, or other processing devices. The terminal device may be user equipment (UE), a mobile device, a user terminal, a cellular phone, a cordless telephone, a personal digital assistant (PDA), a hand-held device, a computing device, an on-board device, a wearable device, or the like. In some possible implementations, the image distortion evaluation method may be implemented by a processor calling computer-readable instructions stored in a memory.

The image distortion evaluation method provided in the embodiment of the present disclosure will be described below with a terminal device as the executive subject.

### Embodiment 1

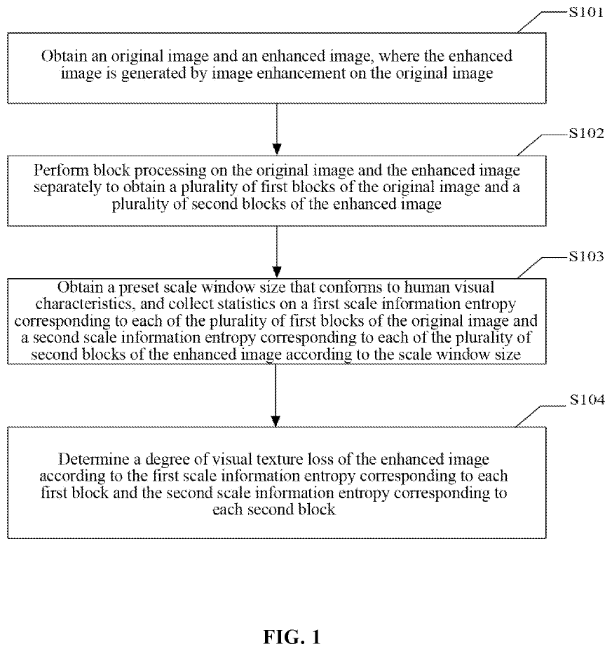

FIG. 1 shows a flowchart of an image distortion evaluation method provided in Embodiment 1 of the present disclosure. The method includes steps S101-S104.

S101: Obtain an original image and an enhanced image, where the enhanced image is generated by image enhancement on the original image.

In a specific implementation, the original image may be obtained and enhanced to obtain the enhanced image after image enhancement.

In a specific implementation, different enhanced images may be obtained by using different image enhancement methods.

S102: Perform block processing on the original image and the enhanced image separately to obtain a plurality of first blocks of the original image and a plurality of second blocks of the enhanced image.

In a specific implementation, the original image and the enhanced image may be first converted into gray images, where the original image is converted into a first gray image and the enhanced image is converted into a second gray image, then information entropies of the converted gray images are computed, and an information entropy difference of the enhanced image relative to the original image may be further computed. Here, the information entropy reflects an amount of information in the image, and the gray image contains texture information of the image, so the information entropy difference between the second gray image and the first gray image may reflect a visual texture loss of the images to some extent.

In order to better reflect regional differences within the images, when the information entropies are computed, the first gray image and the second gray image may be processed in blocks separately to compute an information entropy corresponding to each block. Alternatively, the images may be first split into blocks, and then each block may be converted into a gray image separately.

Generally, too small blocks cause excessively discrete distribution of information entropies and reduce credibility, and too many blocks cause high computational complexity. However, too large blocks or fewer blocks cannot reflect regional differences, reducing the computed information entropy difference. Therefore, when an image is split into blocks, a quantity of blocks may be reasonably selected according to a size of the image and/or a resolution of the image.

Optionally, as a block method, a size of each block may be set between 32 px×32 px and 320 px×320 px. The quantity of blocks may be not less than 100. Here, px is an abbreviation for pixel.

In addition, the blocks may be square. In this case, the number of pixels in each block in length and width directions is equal, which is conducive to improving computational efficiency of information entropies. If an image cannot be evenly split into square blocks, a small quantity of edge pixels may be selectively discarded. This may improve accuracy of computing results, because textures biased to one direction easily occur at a computational level when the number of pixels in each block in the length and width directions is unequal. For example, when the pixels in the length direction of a block are much more than the pixels in the width direction, the computation is insensitive to horizontal textures and excessively sensitive to vertical textures.

For example, based on the foregoing block method, there are three block schemes for a 1920 px×1080 px image:
i. Size of blocks: 120 px×120 px; quantity of blocks: 16×9=144;
ii. Size of blocks: 60 px×60 px; quantity of blocks: 32×18=576;
iii. Size of blocks: 40 px×40 px; quantity of blocks: 48×27=1296.

S103: Obtain a preset scale window size that conforms to human visual characteristics, and collect statistics on a first scale information entropy corresponding to each of the plurality of first blocks of the original image and a second scale information entropy corresponding to each of the plurality of second blocks of the enhanced image according to the scale window size.

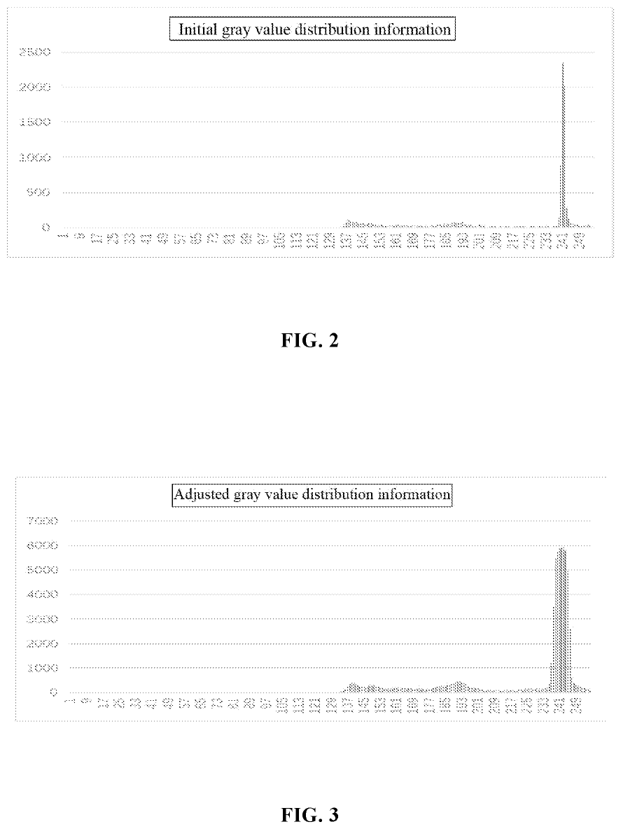

After the foregoing block processing on the first gray image and the second gray image, initial gray value distribution information corresponding to each block of the first gray image and the second gray image may be determined. The initial gray value distribution information includes the number of pixels corresponding to each gray value. As shown in FIG. 2, the initial gray value distribution information is represented by a histogram. Horizontal coordinates represent gray values in a range of [0-255]; and vertical coordinates represent pixels.

Due to varying sensitivity of human eyes to different gray scales, gray values of pixels in blocks are still different after some images are enhanced, but a gray scale range (namely, gray value distribution) corresponding to each gray value is obviously compressed. For example, for any block, initial distribution of gray values of the block is [200, 210, 220, 230, 240, 250]; and the distribution of gray values of the block becomes [230, 235, 240, 245, 250, 255] after image enhancement. Although there are still differences, the distribution is relatively concentrated. In this case, it is difficult for human eyes to distinguish the texture of the block, and the information entropy cannot reflect the differences. For example, the information entropies of the block before and after image enhancement are the same. Therefore, the gray image needs to be adjusted according to the characteristics of human eyes to enhance the visual texture.

On this basis, the embodiment of the present disclosure introduces a scale window to adjust the gray value distribution information. That is, adjusted gray value distribution information corresponding to each block of the first gray image and the second gray image is determined based on initial gray value distribution information corresponding to each block of the first gray image and the second gray image and the preset scale window size that conforms to human visual characteristics, where the number of pixels corresponding to each gray value in the adjusted gray value distribution information is a sum of pixels of each gray value in a target scale window corresponding to the gray value in the initial gray value distribution information, and a size of the target scale window may match the scale window size that conforms to human visual characteristics. Here, the size of the target scale window may be equal to the scale window size that conforms to human visual characteristics.

For example, for a gray value i, pixels having gray values greater than 0.9863×i and less than 1.0135×i are accumulated to obtain the adjusted number of pixels corresponding to the gray value i. For example, 1000 pixels have a gray value of 99, 2000 pixels have a gray value of 100, 3000 pixels have a gray value of 101, and the adjusted number of pixels corresponding to the gray value of 100 is: 1000+2000+3000=6000.

As shown in FIG. 3, the adjusted gray value distribution information is represented by a histogram. Horizontal coordinates represent gray values in a range of [0-255]; and vertical coordinates represent pixels.

The foregoing preset scale window size is [0.9863×i, 1.0135×i], which may be obtained in advance based on the Weber's law. The specific principle is as follows: A perceptible difference between the human eye and light intensity is 0.03×j (j represents brightness). Because common digital images are gamma transformed images, corresponding gamma transformations may be performed on the perceptible differences of human eyes. A default gamma transformation rate is gamma=1/2.2. Therefore, (1−0.03)^{1/2.2}≈0.9863, (1+0.03)^{1/2.2}≈1.0135, and the obtained scale window size is [0.9863×i, 1.0135×i].

After the adjusted gray value distribution information is obtained, the first scale information entropies corresponding to the plurality of first blocks of the original image and the second scale information entropies corresponding to the plurality of second blocks of the enhanced image are determined based on the adjusted gray value distribution information corresponding to each block of the first gray image and the second gray image.

S104: Determine a degree of visual texture loss of the enhanced image according to the first scale information entropy corresponding to each first block and the second scale information entropy corresponding to each second block.

Because the information entropy reflects an amount of information in the image, the information entropy difference may reflect the visual texture loss of the image to some extent. Therefore, a first information entropy difference between the original image and the enhanced image may be determined after the first scale information entropy corresponding to each first block and the second scale information entropy corresponding to each second block are determined; and the degree of visual texture loss of the enhanced image is determined based on the first information entropy difference.

In one implementation, the first information entropy difference using the scale window may be combined with a second information entropy difference that does not use the scale window to comprehensively determine the degree of visual texture loss. Here, the second information entropy difference that does not use the scale window is also determined based on the initial gray value distribution information of each block.

Specifically, the second information entropy difference is determined according to the following steps:

determining, based on initial gray value distribution information corresponding to each of the plurality of first blocks of the original image, a first initial information entropy corresponding to each first block; determining, based on initial gray value distribution information corresponding to each of the plurality of second blocks of the enhanced image, a second initial information entropy corresponding to each second block; and determining the second information entropy difference between the original image and the enhanced image according to the first initial information entropy corresponding to each first block and the second initial information entropy corresponding to each second block.

Then, the degree of visual texture loss of the enhanced image may be determined based on the first information entropy difference and the second information entropy difference.

The foregoing first scale information entropy, second scale information entropy, first initial information entropy, and second initial information entropy (hereinafter referred to as target information entropy) are determined in a similar way. A specific process is as follows:

The initial gray value distribution information and the adjusted gray value distribution information are used as target gray value distribution information separately, the first blocks and the second blocks are used as target blocks separately, and for each target block, the target information entropy corresponding to the target block is determined based on the number of pixels, indicated by the target gray value distribution information, corresponding to each gray value of the target block, and the total number of pixels corresponding to the target block.

As mentioned above, after the target information entropy corresponding to the target block is obtained, a target information entropy difference (the first information entropy difference or the second information entropy difference) between the corresponding blocks of the enhanced image and the original image may be determined based on the target information entropy corresponding to each block.

Specifically, a computational formula for the foregoing target information entropy H may be:

$$H = - {\sum }_{i = 0}^{255} {p}_{i} {log}_{2} ( {p}_{i} ) , \\ where {p}_{i} = \frac{the number of pixels with gray value i in the block}{the total number of pixels in the block} .$$

In this case, a difference of information entropies between the enhanced image and the original image is:

ΔHᵢ^{std}=Hᵢ^{enhanced image}−Hᵢ^{original image}, where ΔHᵢ^{std} is a difference of an information entropy of the it h block of the enhanced image from the original image, Hᵢ^{enhanced image} is a target information entropy of the i^{th} block of the enhanced image, and Hᵢ^{original image} is a target information entropy of the it h block of the original image.

After the differences of information entropies between corresponding blocks of the enhanced image and the original image are obtained, the foregoing first information entropy differences and second information entropy differences (hereinafter referred to as target information entropy differences) are computed. Specifically, the differences of information entropies between the corresponding blocks may be classified first. The differences of information entropies between the corresponding blocks of the enhanced image and the original image are divided into a first class and a second class separately. The differences of information entropies in the first class are greater than or equal to 0, and the differences of information entropies in the second class are less than 0.

Based on the classified results, the foregoing differences of information entropies may be standardized as follows:

First, for the first class:

The differences of information entropies in the first class are set to 0. Here, because the visual texture loss is computed in the embodiment of the present disclosure, the area increased by visual texture is not included in the statistics.

Second, for the second class:

A process of standardizing the differences of information entropies in the second class may include:
1) A mean value of the differences of information entropies in the second class is computed;
A computational formula may be:

$${μ}_{std} = \frac{{\sum }_{i = 1}^{L} Δ {H}_{i}^{std}}{L} ,$$

where L is the total number of blocks of which the differences of information entropies are less than 0.
2) A standard deviation of the differences of information entropies in the second class is computed based on the mean value;
A computational formula may be:

$${σ}_{std} = \sqrt{\frac{{\sum }_{i = 1}^{L} {( {μ}_{std} - Δ {H}_{i}^{std} )}^{2}}{L - 1}} .$$

3) Based on the computed standard deviation and the difference of information entropies corresponding to any block in the second class, a standardized difference of information entropies corresponding to the block is determined.

Specifically, based on the computed standard deviation, the difference of information entropies corresponding to each block in the second class is standardized, for example,

$$Δ {h}_{i}^{std} = \frac{Δ {H}_{i}^{std} - {μ}_{std}}{{σ}_{std}} .$$

Finally, the processed differences of information entropies in the first class and the second class determine the target information entropy differences (the first information entropy differences or the second information entropy differences).

Because the visual texture loss is computed in the embodiment of the present disclosure, all standardized differences of information entropies Δhᵢ^{std} may be converted into values less than 0. Specifically, an offset may be introduced. In this case,

$$Δ {h}_{i}^{std} = \frac{Δ {H}_{i}^{std}}{{σ}_{std}} .$$

In a practical operation, the standardized differences of information entropies may be directly computed based on the formula after the offset is introduced.

After the first information entropy difference or the second information entropy difference is obtained, in one implementation, a square root of a sum of squares of the first information entropy difference and the second information entropy difference may be computed, and a value of the square root is used as a union information entropy difference Δhᵢ^{union}. A computational formula is Δhᵢ^{union}=\sqrt{(Δhᵢ^{std})²+(Δhᵢ^{scale})²}, where Δhᵢ^{scale} is the first information entropy difference.

Then, a sum of union information entropy differences between the respective corresponding blocks of the first gray image and the second gray image may be used as a value to measure the degree of texture loss of the enhanced image compared with the original image. A larger value indicates a more serious visual texture loss. A computational formula is: Δh^{union}=Σᵢ₌₁^{N}Δhᵢ^{union}, where N is a quantity of blocks.

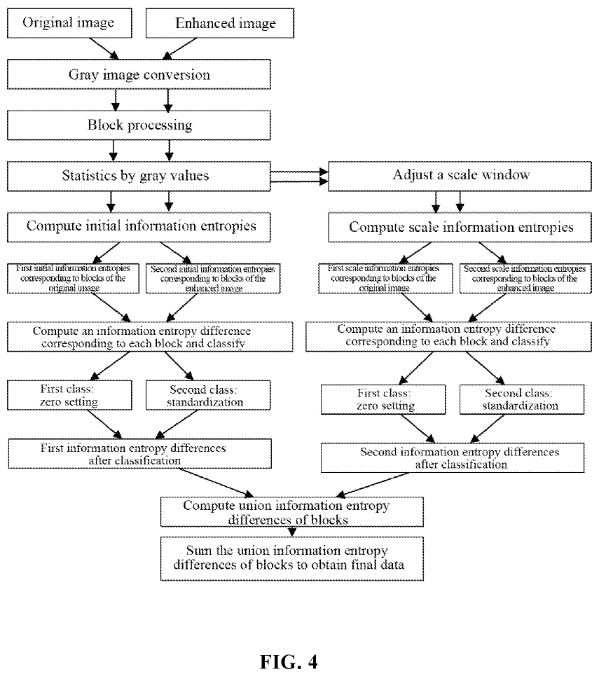

FIG. 4 shows a complete flowchart of obtaining a union information entropy difference in an image distortion evaluation method provided in an embodiment of the present disclosure. After an original image and an enhanced image are obtained, the original image and the enhanced image are converted into gray images and subjected to block processing, statistics on the number of pixels of each gray value in each block is collected, a first initial information entropy corresponding to each first block of the original image and a second initial information entropy corresponding to each second block of the enhanced image are computed, and then a first information entropy difference of the two is obtained; meanwhile, original gray value distribution information is adjusted by using a scale window to obtain a first scale information entropy corresponding to the original image and a second scale information entropy corresponding to the enhanced image, and then a second information entropy difference of the two is obtained. The first information entropy difference and the second information entropy difference are jointly computed to obtain a union information entropy difference of each block. Finally, a visual texture loss of the enhanced image compared with the original image is measured by using a sum of the union information entropy differences of the blocks.

In the embodiment of the present disclosure, information entropies corresponding to the original image and the enhanced image respectively that conform to human visual characteristics more can be obtained by introducing a scale window, then second information entropy differences that conform to human visual characteristics more can be obtained, and the second information entropy differences are combined with original first information entropy differences to evaluate a visual texture loss of the enhanced image more accurately, thereby achieving evaluation on the visual texture loss of the enhanced image without model training while reducing computational complexity.

In addition, as an application, in a case where a plurality of enhanced images are obtained by using a variety of image enhancement methods, an image enhancement method and an enhanced image with a minimum visual texture loss may be selected as a final screening result based on the evaluation results in the embodiments of the present disclosure.

Those skilled in the art may understand that in the foregoing method of the specific implementation, the writing order of steps does not imply a strict execution order and imposes any limitation on the implementation process. A specific execution order of steps should be determined based on functions and possible internal logics.

Based on the same inventive concept, an image distortion evaluation apparatus corresponding to the image distortion evaluation method is further provided in an embodiment of the present disclosure. Because the principle of solving the problem in this embodiment of the present disclosure is similar to that in the image distortion evaluation method described in the foregoing embodiment of the present disclosure, the implementation of the apparatus may refer to the implementation of the method, and any repetition will not be described.

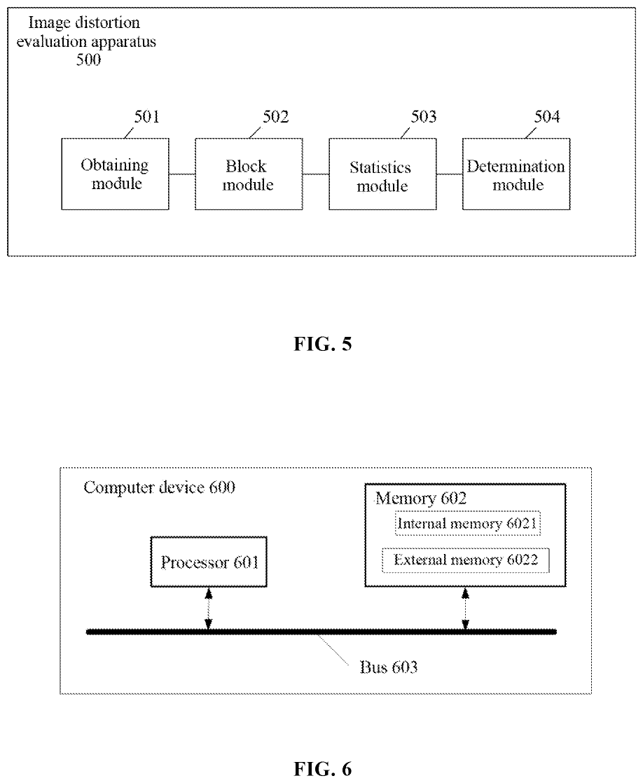

FIG. 5 shows a schematic architecture diagram of an image distortion evaluation apparatus 500 provided in Embodiment 5 of the present disclosure. The image distortion evaluation apparatus 500 includes: an obtaining module 501, a block module 502, a statistics module 503, and a determination module 504, where
the obtaining module 501 is configured to obtain an original image and an enhanced image, where the enhanced image is generated by image enhancement on the original image;
the block module 502 is configured to perform block processing on the original image and the enhanced image separately to obtain a plurality of first blocks of the original image and a plurality of second blocks of the enhanced image;
the statistics module 503 is configured to obtain a preset scale window size that conforms to human visual characteristics, and collect statistics on a first scale information entropy corresponding to each of the plurality of first blocks of the original image and a second scale information entropy corresponding to each of the plurality of second blocks of the enhanced image according to the scale window size; and
the determination module 504 is configured to determine a degree of visual texture loss of the enhanced image according to the first scale information entropy corresponding to each first block and the second scale information entropy corresponding to each second block.

In an optional implementation, the statistics module 503, when collecting statistics on a first scale information entropy corresponding to each of the plurality of first blocks of the original image and a second scale information entropy corresponding to each of the plurality of second blocks of the enhanced image according to the scale window size, is configured to:
determine adjusted gray value distribution information corresponding to each of the plurality of first blocks of the original image based on initial gray value distribution information corresponding to each of the plurality of first blocks of the original image and the scale window size, and determine the first scale information entropy corresponding to each of the plurality of first blocks based on the adjusted gray value distribution information corresponding to each of the plurality of first blocks; and
determine adjusted gray value distribution information corresponding to each of the plurality of second blocks of the enhanced image based on initial gray value distribution information corresponding to each of the plurality of second blocks of the enhanced image and the scale window size, and determine the second scale information entropy corresponding to each of the plurality of second blocks based on the adjusted gray value distribution information corresponding to each of the plurality of second blocks, where
the number of pixels corresponding to each gray value in the adjusted gray value distribution information is a sum of pixels of each gray value in a target scale window corresponding to the gray value in the initial gray value distribution information; and a size of the target scale window matches the scale window size that conforms to human visual characteristics.

In an optional implementation, the determination module 504, when determining a degree of visual texture loss of the enhanced image according to the first scale information entropy corresponding to each first block and the second scale information entropy corresponding to each second block, is configured to:
determine a first information entropy difference between the original image and the enhanced image according to the first scale information entropy corresponding to each first block and the second scale information entropy corresponding to each second block; and
determine the degree of visual texture loss of the enhanced image based on the first information entropy difference.

Optionally implementation, the statistics module 503 is further configured to:
determine, based on initial gray value distribution information corresponding to each of the plurality of first blocks of the original image, a first initial information entropy corresponding to each first block, and determine, based on initial gray value distribution information corresponding to each of the plurality of second blocks of the enhanced image, a second initial information entropy corresponding to each second block; and
determine a second information entropy difference between the original image and the enhanced image according to the first initial information entropy corresponding to each first block and the second initial information entropy corresponding to each second block.

The determination module 504, when determining the degree of visual texture loss of the enhanced image based on the first information entropy difference, is configured to:
determine the degree of visual texture loss of the enhanced image based on the first information entropy difference and the second information entropy difference.

In an optional implementation, the statistics module 503 determines a target information entropy according to the following steps after using the initial gray value distribution information and the adjusted gray value distribution information as target gray value distribution information separately, where the target information entropy is the first scale information entropy, the second scale information entropy, the first initial information entropy, or the second initial information entropy:
using the first blocks and the second blocks as target blocks separately, and for each target block, determining the target information entropy corresponding to the target block based on the number of pixels, indicated by the target gray value distribution information, corresponding to each gray value of the target block, and the total number of pixels corresponding to the target block.

In an optional implementation, the determination module 504 determines a target information entropy difference according to the following steps, where the target information entropy difference is the first information entropy difference or the second information entropy difference:
dividing differences of information entropies between corresponding blocks of the enhanced image and the original image into a first class and a second class, where the differences of information entropies in the first class are greater than or equal to 0, and the differences of information entropies in the second class are less than 0;
setting the differences of information entropies in the first class to 0, computing a standard deviation of the differences of information entropies in the second class, and determining, based on the standard deviation and the difference of information entropies corresponding to any block in the second class, a standardized difference of information entropies corresponding to the block; and
determining the target information entropy difference based on the processed difference of information entropies between the corresponding blocks of the enhanced image and the original image.

In an optional implementation, the determination module 504, when determining the degree of visual texture loss of the enhanced image based on the first information entropy difference and the second information entropy difference, is configured to:
determine a union information entropy difference between the corresponding blocks of the enhanced image and the original image based on the first information entropy difference and the second information entropy difference between the corresponding blocks of the enhanced image and the original image; and
use a sum of union information entropy differences between the respective corresponding blocks of the enhanced image and the original image as a value to measure the degree of texture loss of the enhanced image.

In an optional implementation, the determination module 504, when determining a union information entropy difference between the corresponding blocks of the enhanced image and the original image based on the first information entropy difference and the second information entropy difference between the corresponding blocks of the enhanced image and the original image, is configured to:
compute a square root of a sum of squares of the first information entropy difference and the second information entropy difference, and use a value of the square root as the union information entropy difference.

Descriptions of a processing flow of each module in the apparatus and an interaction flow between modules may refer to relevant descriptions in the foregoing method embodiments, and details are not repeated here.

Based on the same technical idea, embodiments of the present disclosure also provide a computer device. Referring to FIG. 6, a schematic diagram of the structure of the computer device 600 provided by embodiments of the present disclosure includes a processor 601, a memory 602, and a bus 603. wherein the memory 602 is used to store execution instructions and includes a memory 6021 and an external memory 6022; herein the memory 6021, also referred to as an internal memory, is used to temporarily store computing data in the processor 601, and data exchanged with the external memory 6022, such as a hard disk, and the processor 601 exchanges data with the external memory 6022 through the memory 6021, and when the computer device 600 is operating, the processor 601 communicates with the memory 602 through the bus 603 such that the processor 601 is executing instructions for:
obtaining an original image and an enhanced image, wherein the enhanced image is generated by image enhancement on the original image;
performing block processing on the original image and the enhanced image separately to obtain a plurality of first blocks of the original image and a plurality of second blocks of the enhanced image;
obtaining a preset scale window size that conforms to human visual characteristics, and collecting statistics on a first scale information entropy corresponding to each of the plurality of first blocks of the original image and a second scale information entropy corresponding to each of the plurality of second blocks of the enhanced image according to the scale window size; and
determining a degree of visual texture loss of the enhanced image according to the first scale information entropy corresponding to each first block and the second scale information entropy corresponding to each second block.

In one optional embodiment, in the instructions executed by processor 601, the collecting statistics on a first scale information entropy corresponding to each of the plurality of first blocks of the original image and a second scale information entropy corresponding to each of the plurality of second blocks of the enhanced image according to the scale window size comprises:
determining adjusted gray value distribution information corresponding to each of the plurality of first blocks of the original image based on initial gray value distribution information corresponding to each of the plurality of first blocks of the original image and the scale window size, and determining the first scale information entropy corresponding to each of the plurality of first blocks based on the adjusted gray value distribution information corresponding to each of the plurality of first blocks; and
determining adjusted gray value distribution information corresponding to each of the plurality of second blocks of the enhanced image based on initial gray value distribution information corresponding to each of the plurality of second blocks of the enhanced image and the scale window size, and determining the second scale information entropy corresponding to each of the plurality of second blocks based on the adjusted gray value distribution information corresponding to each of the plurality of second blocks, wherein
the number of pixels corresponding to each gray value in the adjusted gray value distribution information is a sum of pixels of each gray value in a target scale window corresponding to the gray value in the initial gray value distribution information; and a size of the target scale window matches the scale window size that conforms to human visual characteristics.

In one optional embodiment, in the instructions executed by processor 601, the determining a degree of visual texture loss of the enhanced image according to the first scale information entropy corresponding to each first block and the second scale information entropy corresponding to each second block comprises:
determining a first information entropy difference between the original image and the enhanced image according to the first scale information entropy corresponding to each first block and the second scale information entropy corresponding to each second block; and
determining the degree of visual texture loss of the enhanced image based on the first information entropy difference.

In one optional embodiment, in the instructions executed by processor 601, further comprises:
determining, based on initial gray value distribution information corresponding to each of the plurality of first blocks of the original image, a first initial information entropy corresponding to each first block, and determining, based on initial gray value distribution information corresponding to each of the plurality of second blocks of the enhanced image, a second initial information entropy corresponding to each second block; and
determining a second information entropy difference between the original image and the enhanced image according to the first initial information entropy corresponding to each first block and the second initial information entropy corresponding to each second block;
wherein the determining the degree of visual texture loss of the enhanced image based on the first information entropy comprises:
determining the degree of visual texture loss of the enhanced image based on the first information entropy difference and the second information entropy difference.

In one optional embodiment, in the instructions executed by processor 601, the initial gray value distribution information and the adjusted gray value distribution information are used as target gray value distribution information separately, and a target information entropy is determined according to the following steps, wherein the target information entropy is the first scale information entropy, the second scale information entropy, the first initial information entropy, or the second initial information entropy:
using the first blocks and the second blocks as target blocks separately, and for each target block, determining the target information entropy corresponding to the target block based on the number of pixels, indicated by the target gray value distribution information, corresponding to each gray value of the target block, and the total number of pixels corresponding to the target block.

In one optional embodiment, in the instructions executed by processor 601, a target information entropy difference is determined according to the following steps, wherein the target information entropy difference is the first information entropy difference or the second information entropy difference:
dividing differences of information entropies between corresponding blocks of the enhanced image and the original image into a first class and a second class, wherein the differences of information entropies in the first class are greater than or equal to 0, and the differences of information entropies in the second class are less than 0;
setting the differences of information entropies in the first class to 0, computing a standard deviation of the differences of information entropies in the second class, and determining, based on the standard deviation and the difference of information entropies corresponding to any block in the second class, a standardized difference of information entropies corresponding to the block; and
determining the target information entropy difference based on the processed difference of information entropies between the corresponding blocks of the enhanced image and the original image.

In one optional embodiment, in the instructions executed by processor 601, the determining the degree of visual texture loss of the enhanced image based on the first information entropy difference and the second information entropy difference comprises:
determining a union information entropy difference between the corresponding blocks of the enhanced image and the original image based on the first information entropy difference and the second information entropy difference between the corresponding blocks of the enhanced image and the original image; and
using a sum of union information entropy differences between the respective corresponding blocks of the enhanced image and the original image as a value to measure the degree of texture loss of the enhanced image.

In one optional embodiment, in the instructions executed by processor 601, the determining a union information entropy difference between the corresponding blocks of the enhanced image and the original image based on the first information entropy difference and the second information entropy difference between the corresponding blocks of the enhanced image and the original image comprises:
computing a square root of a sum of squares of the first information entropy difference and the second information entropy difference, and using a value of the square root as the union information entropy difference.

Embodiments of the present disclosure provide a computer-readable storage medium, wherein the computer-readable storage medium stores a computer program, and the computer program is run by a processor to execute the steps of the image distortion evaluation method. Wherein the storage medium may be a volatile or non-volatile computer-readable storage medium.

Embodiments of the present disclosure also provide a computer program product that carries program code, the program code comprising instructions that can be used to perform the steps of the method of image distortion evaluation described in the method embodiment above, and which will not be repeated herein.

Wherein the computer program product may be embodied specifically by means of hardware, software, or a combination thereof. In one optional embodiment, said computer program product is specifically embodied as a computer storage medium, and in another optional embodiment, the computer program product is specifically embodied as a software product, such as a Software Development Kit (SDK), etc.

It will be clear to those skilled in the art that, for the convenience and brevity of the description, the specific working processes of the systems and apparatus described above may be referred to the corresponding processes in the preceding method embodiments and will not be repeated herein. In the several embodiments provided in this disclosure, it should be understood that the disclosed systems, devices and methods, can be implemented in other ways. The embodiments of the devices described above are merely schematic, for example, the division of the units described, which is only a logical functional division, can be divided in another way when actually implemented, and also, for example, multiple units or components can be combined or can be integrated into another system, or some features can be ignored, or not implemented. On another point, the mutual coupling or direct coupling or communication connection shown or discussed can be indirect coupling or communication connection through some communication interface, device or unit, which can be electrical, mechanical or other forms.

The units illustrated as separate components may or may not be physically separated, and the components displayed as units may or may not be physical units, i.e., they may be located in one place or may be distributed to a plurality of network units. Some or all of these units can be selected according to practical needs to achieve the purpose of this embodiment Besides, each functional unit in various embodiments of the present disclosure may be integrated in a single processing unit, or each unit may be physically present separately, or two or more units may be integrated in a single unit.

The functionality, when implemented in the form of a software functional unit and sold or used as a separate product, may be stored in a processor-executable, non-volatile computer readable storage medium. It is understood that the technical solution of the present disclosure, or that part of the technical solution that essentially contributes to the prior art, may be embodied in the form of a software product stored in a storage medium comprising a number of instructions to cause a computer device (which may be a personal computer, a server, or a network device, etc.) to perform all or some of the steps of the method described in various embodiments of the present disclosure. All or some of the steps of the method described in various embodiments of the present disclosure. The aforementioned storage media includes: USB flash drives, removable hard drives, Read-Only Memory (ROM), Random Access Memory (RAM), disks, or CD-ROMs, and other media that can store program code.

Finally, it should be noted that the above described embodiments are only specific embodiments of the present disclosure to illustrate the technical solution of the present disclosure, not to limit it, and the scope of protection of the present disclosure is not limited thereto, although the present disclosure is described in detail with reference to the foregoing embodiments, it should be understood by a person of ordinary skill in the art that any person of skill in the art, within the technical scope disclosed by the present disclosure, any person skilled in the art, within the scope of the technology disclosed in the present disclosure, may still modify or readily conceive of changes to the technical solutions described in the preceding embodiments, or make equivalent substitutions to some of the technical features thereof; and these modifications, changes or substitutions do not cause the essence of the corresponding technical solutions to depart from the spirit and scope of the technical solutions of the embodiments of the present disclosure, and shall be covered within the scope of protection of the present disclosure. Therefore, the scope of protection of the present disclosure shall be stated to be subject to the scope of protection of the claims.

1. An image distortion evaluation method, comprising:
obtaining an original image and an enhanced image, wherein the enhanced image is generated by image enhancement on the original image;
performing block processing on the original image and the enhanced image separately to obtain a plurality of first blocks of the original image and a plurality of second blocks of the enhanced image;
obtaining a preset scale window size that conforms to human visual characteristics, and collecting statistics on a first scale information entropy corresponding to each of the plurality of first blocks of the original image and a second scale information entropy corresponding to each of the plurality of second blocks of the enhanced image according to the scale window size; and
determining a degree of visual texture loss of the enhanced image according to the first scale information entropy corresponding to each first block and the second scale information entropy corresponding to each second block.

2. The method according to claim 1, wherein the collecting statistics on a first scale information entropy corresponding to each of the plurality of first blocks of the original image and a second scale information entropy corresponding to each of the plurality of second blocks of the enhanced image according to the scale window size comprises:
determining adjusted gray value distribution information corresponding to each of the plurality of first blocks of the original image based on initial gray value distribution information corresponding to each of the plurality of first blocks of the original image and the scale window size, and determining the first scale information entropy corresponding to each of the plurality of first blocks based on the adjusted gray value distribution information corresponding to each of the plurality of first blocks; and
determining adjusted gray value distribution information corresponding to each of the plurality of second blocks of the enhanced image based on initial gray value distribution information corresponding to each of the plurality of second blocks of the enhanced image and the scale window size, and determining the second scale information entropy corresponding to each of the plurality of second blocks based on the adjusted gray value distribution information corresponding to each of the plurality of second blocks, wherein
the number of pixels corresponding to each gray value in the adjusted gray value distribution information is a sum of pixels of each gray value in a target scale window corresponding to the gray value in the initial gray value distribution information; and a size of the target scale window matches the scale window size that conforms to human visual characteristics.

3. The method according to claim 1, wherein the determining a degree of visual texture loss of the enhanced image according to the first scale information entropy corresponding to each first block and the second scale information entropy corresponding to each second block comprises:
determining a first information entropy difference between the original image and the enhanced image according to the first scale information entropy corresponding to each first block and the second scale information entropy corresponding to each second block; and
determining the degree of visual texture loss of the enhanced image based on the first information entropy difference.

4. The method according to claim 3, wherein the method further comprises:
determining, based on initial gray value distribution information corresponding to each of the plurality of first blocks of the original image, a first initial information entropy corresponding to each first block, and determining, based on initial gray value distribution information corresponding to each of the plurality of second blocks of the enhanced image, a second initial information entropy corresponding to each second block; and
determining a second information entropy difference between the original image and the enhanced image according to the first initial information entropy corresponding to each first block and the second initial information entropy corresponding to each second block;
wherein the determining the degree of visual texture loss of the enhanced image based on the first information entropy comprises:
determining the degree of visual texture loss of the enhanced image based on the first information entropy difference and the second information entropy difference.

5. The method according to claim 2, wherein the initial gray value distribution information and the adjusted gray value distribution information are used as target gray value distribution information separately, and a target information entropy is determined according to the following steps, wherein the target information entropy is the first scale information entropy, the second scale information entropy, the first initial information entropy, or the second initial information entropy:
using the first blocks and the second blocks as target blocks separately, and for each target block, determining the target information entropy corresponding to the target block based on the number of pixels, indicated by the target gray value distribution information, corresponding to each gray value of the target block, and the total number of pixels corresponding to the target block.

6. The method according to claim 3, wherein a target information entropy difference is determined according to the following steps, wherein the target information entropy difference is the first information entropy difference or the second information entropy difference:
dividing differences of information entropies between corresponding blocks of the enhanced image and the original image into a first class and a second class, wherein the differences of information entropies in the first class are greater than or equal to 0, and the differences of information entropies in the second class are less than 0;
setting the differences of information entropies in the first class to 0, computing a standard deviation of the differences of information entropies in the second class, and determining, based on the standard deviation and the difference of information entropies corresponding to any block in the second class, a standardized difference of information entropies corresponding to the block; and
determining the target information entropy difference based on the processed difference of information entropies between the corresponding blocks of the enhanced image and the original image.

7. The method according to claim 4, wherein the determining the degree of visual texture loss of the enhanced image based on the first information entropy difference and the second information entropy difference comprises:
determining a union information entropy difference between the corresponding blocks of the enhanced image and the original image based on the first information entropy difference and the second information entropy difference between the corresponding blocks of the enhanced image and the original image; and
using a sum of union information entropy differences between the respective corresponding blocks of the enhanced image and the original image as a value to measure the degree of texture loss of the enhanced image.

8. The method according to claim 7, wherein the determining a union information entropy difference between the corresponding blocks of the enhanced image and the original image based on the first information entropy difference and the second information entropy difference between the corresponding blocks of the enhanced image and the original image comprises:
computing a square root of a sum of squares of the first information entropy difference and the second information entropy difference, and using a value of the square root as the union information entropy difference.

9. (canceled)

10. A computer device, comprising a processor, a memory, and a bus, wherein the memory stores machine-readable instructions executable by the processor; when the computer device is running, the processor communicates with the memory through the bus; and when the machine-readable instructions are executed by the processor, operations are executed, the operations comprising:
obtaining an original image and an enhanced image, wherein the enhanced image is generated by image enhancement on the original image;
performing block processing on the original image and the enhanced image separately to obtain a plurality of first blocks of the original image and a plurality of second blocks of the enhanced image;
obtaining a preset scale window size that conforms to human visual characteristics, and collecting statistics on a first scale information entropy corresponding to each of the plurality of first blocks of the original image and a second scale information entropy corresponding to each of the plurality of second blocks of the enhanced image according to the scale window size; and
determining a degree of visual texture loss of the enhanced image according to the first scale information entropy corresponding to each first block and the second scale information entropy corresponding to each second block.

11. A non-transitory computer-readable storage medium, wherein the computer-readable storage medium stores a computer program, and the computer program is run by a processor to execute operations comprising:
obtaining an original image and an enhanced image, wherein the enhanced image is generated by image enhancement on the original image;
performing block processing on the original image and the enhanced image separately to obtain a plurality of first blocks of the original image and a plurality of second blocks of the enhanced image;
obtaining a preset scale window size that conforms to human visual characteristics, and collecting statistics on a first scale information entropy corresponding to each of the plurality of first blocks of the original image and a second scale information entropy corresponding to each of the plurality of second blocks of the enhanced image according to the scale window size; and
determining a degree of visual texture loss of the enhanced image according to the first scale information entropy corresponding to each first block and the second scale information entropy corresponding to each second block.

12. The method according to claim 4, wherein the initial gray value distribution information and the adjusted gray value distribution information are used as target gray value distribution information separately, and a target information entropy is determined according to the following steps, wherein the target information entropy is the first scale information entropy, the second scale information entropy, the first initial information entropy, or the second initial information entropy:
using the first blocks and the second blocks as target blocks separately, and for each target block, determining the target information entropy corresponding to the target block based on the number of pixels, indicated by the target gray value distribution information, corresponding to each gray value of the target block, and the total number of pixels corresponding to the target block.

13. The method according to claim 4, wherein a target information entropy difference is determined according to the following steps, wherein the target information entropy difference is the first information entropy difference or the second information entropy difference:
dividing differences of information entropies between corresponding blocks of the enhanced image and the original image into a first class and a second class, wherein the differences of information entropies in the first class are greater than or equal to 0, and the differences of information entropies in the second class are less than 0;
setting the differences of information entropies in the first class to 0, computing a standard deviation of the differences of information entropies in the second class, and determining, based on the standard deviation and the difference of information entropies corresponding to any block in the second class, a standardized difference of information entropies corresponding to the block; and
determining the target information entropy difference based on the processed difference of information entropies between the corresponding blocks of the enhanced image and the original image.

14. The computer device according to claim 10, wherein the collecting statistics on a first scale information entropy corresponding to each of the plurality of first blocks of the original image and a second scale information entropy corresponding to each of the plurality of second blocks of the enhanced image according to the scale window size comprises:
determining adjusted gray value distribution information corresponding to each of the plurality of first blocks of the original image based on initial gray value distribution information corresponding to each of the plurality of first blocks of the original image and the scale window size, and determining the first scale information entropy corresponding to each of the plurality of first blocks based on the adjusted gray value distribution information corresponding to each of the plurality of first blocks; and
determining adjusted gray value distribution information corresponding to each of the plurality of second blocks of the enhanced image based on initial gray value distribution information corresponding to each of the plurality of second blocks of the enhanced image and the scale window size, and determining the second scale information entropy corresponding to each of the plurality of second blocks based on the adjusted gray value distribution information corresponding to each of the plurality of second blocks, wherein
the number of pixels corresponding to each gray value in the adjusted gray value distribution information is a sum of pixels of each gray value in a target scale window corresponding to the gray value in the initial gray value distribution information; and a size of the target scale window matches the scale window size that conforms to human visual characteristics.

15. The computer device according to claim 10, wherein the determining a degree of visual texture loss of the enhanced image according to the first scale information entropy corresponding to each first block and the second scale information entropy corresponding to each second block comprises:
determining a first information entropy difference between the original image and the enhanced image according to the first scale information entropy corresponding to each first block and the second scale information entropy corresponding to each second block; and
determining the degree of visual texture loss of the enhanced image based on the first information entropy difference.

16. The computer device according to claim 15, the image distortion evaluation method further comprises:
determining, based on initial gray value distribution information corresponding to each of the plurality of first blocks of the original image, a first initial information entropy corresponding to each first block, and determining, based on initial gray value distribution information corresponding to each of the plurality of second blocks of the enhanced image, a second initial information entropy corresponding to each second block; and
determining a second information entropy difference between the original image and the enhanced image according to the first initial information entropy corresponding to each first block and the second initial information entropy corresponding to each second block;
wherein the determining the degree of visual texture loss of the enhanced image based on the first information entropy comprises:
determining the degree of visual texture loss of the enhanced image based on the first information entropy difference and the second information entropy difference.

17. The computer device according to claim 14, wherein the initial gray value distribution information and the adjusted gray value distribution information are used as target gray value distribution information separately, and a target information entropy is determined according to the following steps, wherein the target information entropy is the first scale information entropy, the second scale information entropy, the first initial information entropy, or the second initial information entropy:
using the first blocks and the second blocks as target blocks separately, and for each target block, determining the target information entropy corresponding to the target block based on the number of pixels, indicated by the target gray value distribution information, corresponding to each gray value of the target block, and the total number of pixels corresponding to the target block.

18. The computer device according to claim 15, wherein a target information entropy difference is determined according to the following steps, wherein the target information entropy difference is the first information entropy difference or the second information entropy difference:
dividing differences of information entropies between corresponding blocks of the enhanced image and the original image into a first class and a second class, wherein the differences of information entropies in the first class are greater than or equal to 0, and the differences of information entropies in the second class are less than 0;
setting the differences of information entropies in the first class to 0, computing a standard deviation of the differences of information entropies in the second class, and determining, based on the standard deviation and the difference of information entropies corresponding to any block in the second class, a standardized difference of information entropies corresponding to the block; and
determining the target information entropy difference based on the processed difference of information entropies between the corresponding blocks of the enhanced image and the original image.

19. The computer device according to claim 16, wherein the determining the degree of visual texture loss of the enhanced image based on the first information entropy difference and the second information entropy difference comprises:
determining a union information entropy difference between the corresponding blocks of the enhanced image and the original image based on the first information entropy difference and the second information entropy difference between the corresponding blocks of the enhanced image and the original image; and
using a sum of union information entropy differences between the respective corresponding blocks of the enhanced image and the original image as a value to measure the degree of texture loss of the enhanced image.

20. The computer device according to claim 19, wherein the determining a union information entropy difference between the corresponding blocks of the enhanced image and the original image based on the first information entropy difference and the second information entropy difference between the corresponding blocks of the enhanced image and the original image comprises:
computing a square root of a sum of squares of the first information entropy difference and the second information entropy difference, and using a value of the square root as the union information entropy difference.
